(19) United States
(12) Patent Application Publication
(10) Pub. No.: US 2025/0044441 A1
(43) Pub. Date: Feb. 6, 2025

(54) RADAR APPARATUS

(71) Applicant: Mitsubishi Electric Corporation, Tokyo (JP)

(72) Inventors: Fuyuki FUKUSHIMA, Tokyo (JP); Satoshi KAGEME, Tokyo (JP); Kei SUWA, Tokyo (JP)

(73) Assignee: Mitsubishi Electric Corporation, Tokyo (JP)

(21) Appl. No.: 18/922,537

(22) Filed: Oct. 22, 2024

Related U.S. Application Data
(63) Continuation of application No. PCT/JP2022/022574, filed on Jun. 3, 2022.

(51) Int. Cl. G01S 13/87; G01S 7/292; G01S 13/58

(52) U.S. Cl. CPC G01S 13/87; G01S 7/2921; G01S 13/582

(57) ABSTRACT

A radar apparatus according to the present disclosure is provided with: an LPRF radar device that emits an LPRF radio wave toward the atmosphere and that receives a reflection wave reflected by a target; and an HPRF radar device that emits an HPRF radio wave toward the atmosphere and that receives a reflection wave reflected by the target. The LPRF radar device (1000) and the HPRF radar device each include a signal processing system having an LPRF system and an HPRF system. The radar apparatus is further provided with a target detection processing unit that detects the position and velocity of the target on the basis of information transmitted from the signal processing system included in the LPRF radar device and information transmitted from the signal processing system included in the HPRF radar device.

### CROSS REFERENCE TO RELATED APPLICATION

This application is a Continuation of PCT International Application No. PCT/JP2022/022574, filed on Jun. 3, 2022, which is hereby expressly incorporated by reference into the present application.

### TECHNICAL FIELD

The present disclosure relates to a radar apparatus.

### BACKGROUND ART

In the technical field of radar apparatuses, a technique for improving a detection rate and reducing an erroneous detection rate is known. For example, Patent Literature 1 discloses a technique of, at the time of measuring a range and a velocity, transmitting a signal modulated by a signal obtained by encoding a pulse train, performing correlation processing on a received signal by a reference signal for each of a plurality of velocities, and outputting the velocity of the reference signal whose correlation output exceeds a predetermined threshold and a position based on a correlation result as a distance.

### CITATION LIST

### Patent Literature

Patent Literature 1: JP 2014-182010 A

### SUMMARY OF INVENTION

### Technical Problem

It is conceivable to link a plurality of radar apparatuses to detect a target that is to be detected. In particular, when a plurality of radar apparatuses emitting radio waves having different PRFs is linked, it is expected to detect a target (Tgt) without being affected by noise on the basis of various types of information as compared with detection of a target using radio waves of one PRF. However, as far as the inventor is aware, there is no literature that discloses how to link a plurality of radar apparatuses.

### Solution to Problem

A radar apparatus according to the present disclosure includes: an LPRF-Radar to emit an LPRF radio wave toward atmosphere and receive a reflection wave reflected by a target; and an HPRF-Radar to emit an HPRF radio wave toward atmosphere and receive the reflection wave reflected by the target, wherein the LPRF-Radar and the HPRF-Radar each include a signal processor including an LPRF system and an HPRF system, the radar apparatus further comprising a target detection processor to detect a position and a velocity of the target on the basis of information transmitted from the signal processor included in the LPRF-Radar and information transmitted from the signal processor included in the HPRF-Radar. The signal processor included in each of the LPRF-Radar and the HPRF-Radar includes, a range-velocity map generator to generate a range-velocity map; an interpolation processor to interpolate and correct a range bin and a Doppler bin in the range-velocity map in consideration of information obtained by the LPRF system and information obtained by the HPRF system; an integration processor to perform integration processing; and a comparison processor to compare a component of a signal processed by the integration processor with a preset threshold value.

### Advantageous Effects of Invention

The radar apparatus according to the present disclosure has the above-described configuration, and thus, it is possible to link a plurality of radar apparatuses emitting radio waves having different PRFs. Due to this effect, the radar apparatus according to the present disclosure can detect a target (Tgt) that is resistant to noise based on various types of information as compared with detection of a target using radio waves of one PRF.

### BRIEF DESCRIPTION OF DRAWINGS

FIG. 1 is a block diagram illustrating an example of a functional configuration of a radar apparatus according to the present disclosure.

FIG. 2 is a block diagram illustrating an example of a functional configuration of a reception system 600 used in the radar apparatus according to the present disclosure.

FIG. 3 is a block diagram illustrating an example of a functional configuration of a signal processing system 700 used in the radar apparatus according to the present disclosure.

FIG. 4 is an explanatory diagram illustrating a mode of an integration processing unit 760 in the radar apparatus according to a first embodiment.

FIG. 5 is an explanatory diagram for describing an azimuth angle and an elevation angle.

FIG. 6 is an explanatory diagram illustrating the detail of processing performed by a range-velocity map generating unit 740-1 in the radar apparatus according to the first embodiment.

FIG. 7 is an explanatory diagram illustrating the detail of processing performed by a range-velocity map generating unit 740-2 in the radar apparatus according to the first embodiment.

FIG. 8 is an explanatory diagram illustrating velocity-axis correction that is the detail of processing performed by an interpolation processing unit 750 in the radar apparatus according to the first embodiment.

FIG. 9 is an explanatory diagram illustrating distance-axis correction that is the detail of processing performed by the interpolation processing unit 750 in the radar apparatus according to the first embodiment.

FIG. 10 is a diagram illustrating an example of a range-velocity map obtained by the radar apparatus according to the present disclosure.

FIG. 11 is a flowchart illustrating a procedure of grouping processing performed by a target detection processing unit 3000 in the radar apparatus according to the first embodiment.

FIGS. 12A to 12D are explanatory diagrams illustrating the procedure of the grouping processing performed by the target detection processing unit 3000 in the radar apparatus according to the first embodiment.

FIG. 13 is an explanatory diagram illustrating a mode of a partial functional block in a radar apparatus according to a second embodiment.

FIG. 14 is an explanatory diagram illustrating a mode of a partial functional block in a radar apparatus according to a third embodiment.

FIG. 15 is a block diagram illustrating a detailed functional configuration of a pulse compression unit 730 (730-F) in the radar apparatus according to the third embodiment.

FIG. 16 is a first explanatory diagram illustrating a mode of a partial functional block in a radar apparatus according to a fourth embodiment.

FIG. 17 is a second explanatory diagram illustrating a mode of a partial functional block in the radar apparatus according to the fourth embodiment.

FIG. 18 is an explanatory diagram illustrating a mode of a partial functional block in a radar apparatus according to a fifth embodiment.

FIG. 19 is a block diagram illustrating a detailed functional configuration of an integration processing unit 760 in the radar apparatus according to the fifth embodiment.

FIG. 20 is an explanatory diagram illustrating, in time series, a state in which the radar apparatus according to the fifth embodiment performs transmission and reception over a plurality of CPIs.

FIG. 21 is an explanatory diagram illustrating a mode of a partial functional block in a radar apparatus according to a sixth embodiment.

FIG. 22 is a range-velocity map for describing a state in which the radar apparatus according to the sixth embodiment sets an ambiguity range.

### DESCRIPTION OF EMBODIMENTS

### First Embodiment

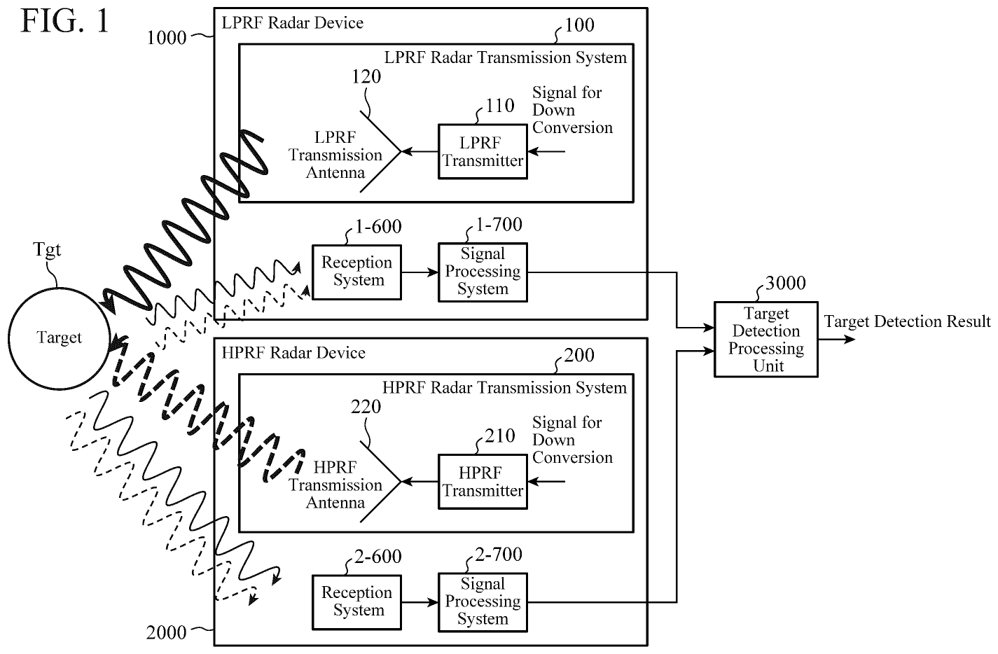

FIG. 1 is a block diagram illustrating an example of a functional configuration of a radar apparatus according to the present disclosure. As illustrated in FIG. 1, the radar apparatus according to the present disclosure includes an LPRF radar device 1000, an HPRF radar device 2000, and a target detection processing unit 3000. LPRF means a low pulse repetition frequency. LPRF has small range ambiguity, and thus is suitable for observing the distance of a target (Tgt). HPRF means a high pulse repetition frequency. HPRF has small velocity ambiguity, and thus is suitable for observing the velocity of the target (Tgt).

The LPRF radar device 1000 includes three systems that are an LPRF radar transmission system 100, a reception system 600, and a signal processing system 700. In FIG. 1, the reception system 600 and the signal processing system 700 in the LPRF radar device 1000 are represented by adding “1-” in front of the reference signs. In the present specification, in a case where it is intended to emphasize that the component is included in the LPRF radar device 1000, “1-” is also added in front of the reference sign, such as “1-600” and “1-700”.

The HPRF radar device 2000 includes three systems that are an HPRF radar transmission system 200, a reception system 600, and a signal processing system 700. In FIG. 1, the reception system 600 and the signal processing system 700 in the HPRF radar device 2000 are represented by adding “2-” in front of the reference signs. In the present specification, in a case where it is intended to emphasize that the component is included in the HPRF radar device 2000, “2-” is also added in front of the reference sign, such as “2-600” and “2-700”.

A thick wavy-line arrow in FIG. 1 indicates that an LPRF pulse generated by an LPRF transmitter 110 is transmitted toward the target (Tgt) by an LPRF transmission antenna 120.

A thin wavy-line arrow in FIG. 1 indicates the LPRF pulse (hereinafter, referred to as “LPRF reflection wave”) reflected by the target (Tgt). The LPRF reflection wave is received by the reception system 600 (1-600, 2-600) of each of the LPRF radar device 1000 and the HPRF radar device 2000.

A thick wavy dot-line arrow in FIG. 1 indicates that an HPRF pulse generated by an HPRF transmitter 210 is transmitted toward the target (Tgt) by an HPRF transmission antenna 220.

A thin wavy dot-line arrow in FIG. 1 indicates the HPRF pulse (hereinafter, referred to as “HPRF reflection wave”) reflected by the target (Tgt). The HPRF reflection wave is received by the reception system 600 (1-600, 2-600) of each of the LPRF radar device 1000 and the HPRF radar device 2000.

As illustrated in FIG. 1, the LPRF radar transmission system 100 includes the LPRF transmitter 110 and the LPRF transmission antenna 120.

As illustrated in FIG. 1, the HPRF radar transmission system 200 includes the HPRF transmitter 210 and the HPRF transmission antenna 220.

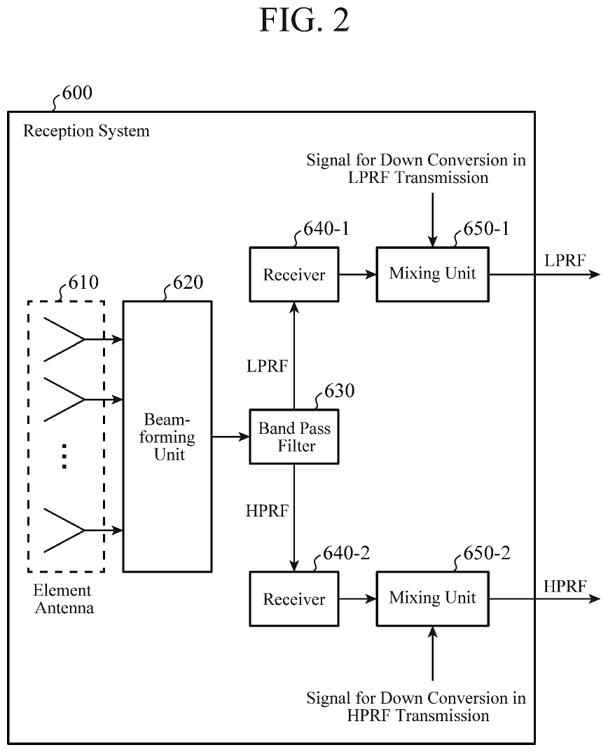

FIG. 2 is a block diagram illustrating an example of a functional configuration of the reception system 600 used in the radar apparatus according to the present disclosure. As illustrated in FIG. 1, the reception system 600 used in the radar apparatus according to the present disclosure is included in each of the LPRF radar device 1000 and the HPRF radar device 2000, and the reception systems 600 (1-600 and 2-600) included in the respective radar devices may have the same structure.

As illustrated in FIG. 2, the reception system 600 includes an element antenna 610, a beam-forming unit 620, a band pass filter 630, a receiver 640 (640-1, 640-2), and a mixing unit 650 (650-1, 650-2). As illustrated in FIG. 2, the reception system 600 is divided into an LPRF system and an HPRF system from a stage subsequent to the band pass filter 630 to an output. The components in the LPRF system are the receiver 640-1 and the mixing unit 650-1. The components in the HPRF system are the reception system 640-2 and the mixing unit 650-2.

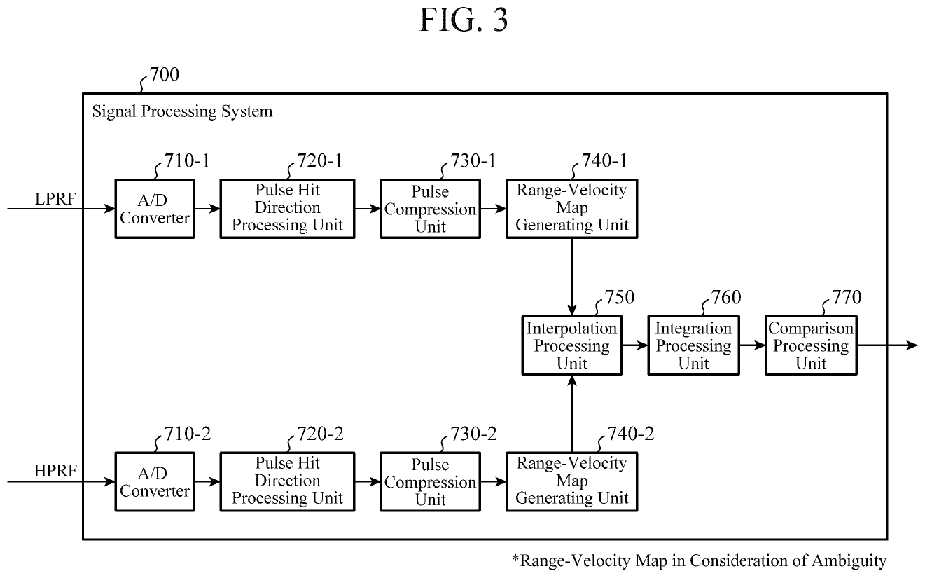

FIG. 3 is a block diagram illustrating an example of a functional configuration of the signal processing system 700 used in the radar apparatus according to the present disclosure. As illustrated in FIG. 3, the signal processing system 700 includes an AD converter 710 (710-1, 710-2), a pulse hit direction processing unit 720 (720-1, 720-2), a pulse compression unit 730 (730-1, 730-2), a range-velocity map generating unit 740 (740-1, 740-2), an interpolation processing unit 750, an integration processing unit 760, and a comparison processing unit 770. As illustrated in FIG. 1, the signal processing system 700 used in the radar apparatus according to the present disclosure is included in each of the LPRF radar device 1000 and the HPRF radar device 2000, and the signal processing systems 700 (1-700 and 2-700) included in the respective radar devices may have the same structure.

As illustrated in FIG. 3, the signal processing system 700 is divided into an LPRF system and an HPRF system from the input to the preceding stage of the interpolation processing unit 750. The components in the LPRF system are the AD converter 710-1, the pulse hit direction processing unit 720-1, the pulse compression unit 730-1, and the range-velocity map generating unit 740-1. The components in the HPRF system are the AD converter 710-2, the pulse hit direction processing unit 720-2, the pulse compression unit 730-2, and the range-velocity map generating unit 740-2.

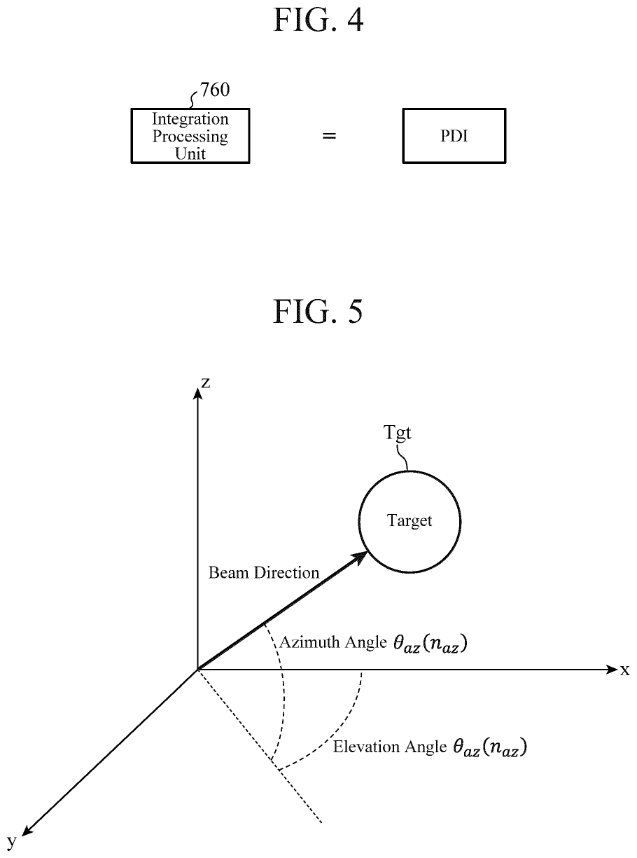

FIG. 4 is an explanatory diagram illustrating a mode of the integration processing unit 760 in the radar apparatus according to a first embodiment. As illustrated in FIG. 4, in the radar apparatus according to the first embodiment, the integration processing unit 760 may perform post detection integration (PDI). More specifically, in the radar apparatus according to the first embodiment, the integration processing unit 760 performs incoherent integration, that is, frequency domain integration, on a range-velocity map sent from the interpolation processing unit 750.

### <<Beam-Forming Unit 620 Included in Reception System 600>>

The beam-forming unit 620 included in the reception system 600 is a component that separates a signal received by the element antenna 610 into a plurality of domains defined by an azimuth angle and an elevation angle.

FIG. 5 is an explanatory diagram for describing an azimuth angle and an elevation angle. FIG. 5 illustrates a space in a left-handed XYZ coordinate system, and illustrates that a beam direction can be expressed by an azimuth angle and an elevation angle.

In FIG. 5, the azimuth angle of the beam is represented by the letters θ_{az}(n_{az}). Here, the argument n_{az} is a number attached to the azimuth angle, and is a natural number from 1 to N_{az}. That is, it is assumed that N_{az} different azimuth angles are defined in advance in the radar apparatus according to the present disclosure.

In FIG. 5, the elevation angle of the beam is represented by the letters θₑₗ(nₑₗ). Here, the argument nₑₗ is a number attached to the elevation angle, and is a natural number from 1 to Nₑₗ. That is, it is assumed that Nₑₗ different elevation angles are defined in advance in the radar apparatus according to the present disclosure.

The beam-forming unit 620 outputs a signal (S_{j, naz, nel}(t)) at time t. The signal (S_{j, naz, nel}(t)) output from the beam-forming unit 620 is sent to the band pass filter 630.

### <<Band Pass Filter 630 Included in Reception System 600>>

The band pass filter 630 included in the reception system 600 is a component that separates the signal (S_{j, naz, nel}(t)) transmitted from the beam-forming unit 620 into the LPRF system and the HPRF system. Specifically, the band pass filter 630 includes bandpass filters (for B₁ and B₂) for a band (B₁) of the LPRF pulse and a band (B₂) of the HPRF pulse.

A signal component passing through the band (B₁) of the LPRF pulse in the band pass filter 630 is sent to the receiver 640-1. At a stage subsequent to the receiver 640-1, it may be considered that the same processing as that of the radar apparatus according to the related art is performed. The signal component that has passed through the band (B₁) of the LPRF pulse finally turns into a range-Doppler signal (S_{rd1}) in the pulse compression unit 730-1 illustrated in FIG. 3, and is sent to the range-velocity map generating unit 740-1. In the character S_{rd1} representing the range-Doppler signal, the subscript rd is an acronym for range-Doppler, which is English for range-Doppler, and the subscript 1 indicates the LPRF system. The range-Doppler signal (S_{rd1}) is created for each of n_{az} and nₑₗ.

A signal component passing through the band (B) of the HPRF pulse in the band pass filter 630 is sent to the receiver 640-2. At a stage subsequent to the receiver 640-2, it may be considered that the same processing as that of the radar apparatus according to the related art is performed. The signal component that has passed through the band (B₂) of the HPRF pulse finally turns into a range-Doppler signal (S_{rd2}) in the pulse compression unit 730-2 illustrated in FIG. 3, and is sent to the range-velocity map generating unit 740-2. The range-Doppler signal (S_{rd2}) is created for each of n_{az} and nₑₗ.

### <<Range-Velocity Map Generating Unit 740-1 in LPRF System Included in Signal Processing System 700>>

The range-velocity map generating unit 740-1 in the LPRF system included in the signal processing system 700 is a component that generates a range-velocity map. The range-velocity map generating unit 740-1 in the LPRF system considers ambiguity (hereinafter, referred to as “velocity ambiguity (V_{amb})”) of the Doppler velocity when generating the range-velocity map.

Assuming that the velocity of the target (Tgt) related to a target signal of the n_{d}th Doppler bin is v₁(n_{d}), a ghost including the velocity ambiguity (V_{amb}) can be any v₁ expressed by the following expression in principle.

V₁=v̅₁̅(n_{d})+nV_{amb}
wherein

vₐₘₕ=c/2f₁T_{LPRI}

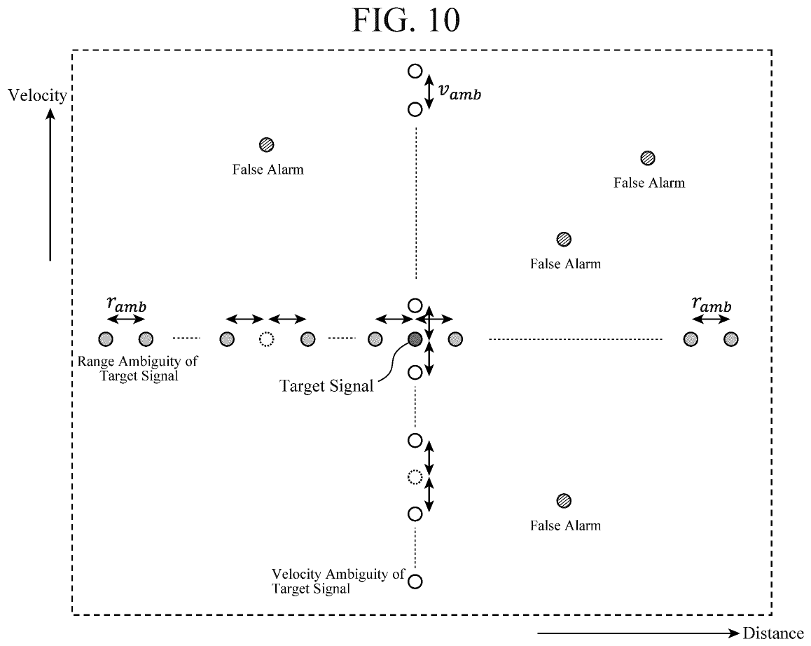

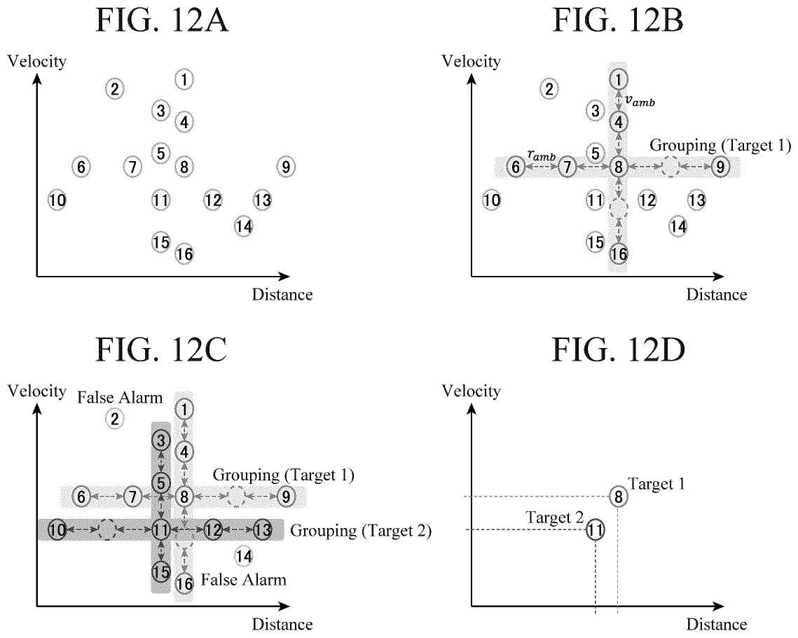

Here, n is an integer. In Expression (1), c represents the speed of light, f₁ represents the transmission frequency of the LPRF radar device 1000, and T_{LPRI} represents the pulse repetition period of the LPRF pulse. In addition, the horizontal bar of the accent symbol used in Expression (1) indicates a value related to a real image that does not include ambiguity. From another point of view, Expression (1) represents that the velocity ambiguity (V_{amb}) regularly occurs. Note that the detail of the ghost represented in Expression (1) will be apparent from the description of FIGS. 10 and 12 described later.

The range-velocity map generating unit 740-1 in the LPRF system performs processing of connecting the range-velocity maps in consideration of the velocity ambiguity (V_{amb}).

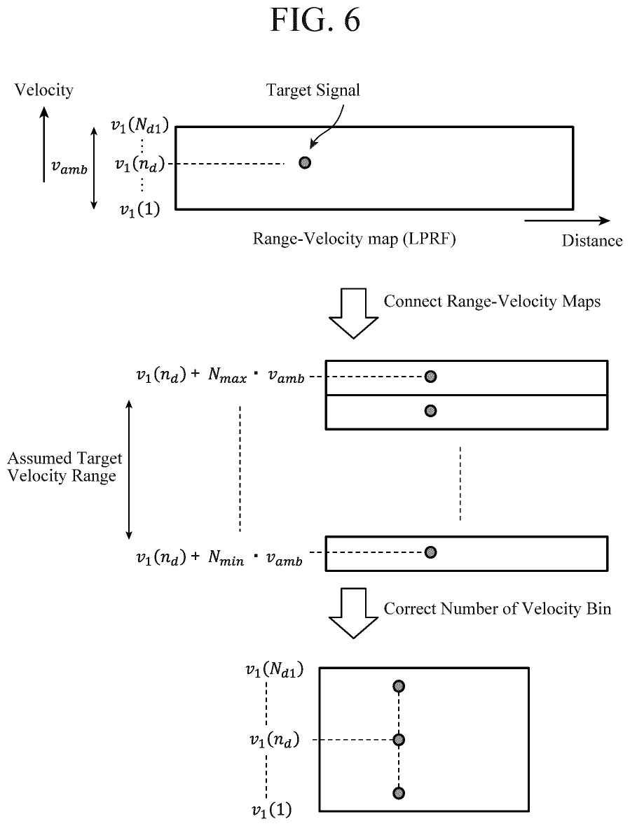

FIG. 6 is an explanatory diagram illustrating the detail of the processing performed by the range-velocity map generating unit 740-1 in the radar apparatus according to the first embodiment.

The upper part of FIG. 6 illustrates that the Doppler bin (n_{d}, 1 to N_{d1}) is set in consideration of the magnitude of the velocity ambiguity (V_{amb}).

The middle part of FIG. 6 illustrates a state in which the range-velocity map generating unit 740-1 in the LPRF system connects the range-velocity maps. A line segment with a double-headed arrow having a description of “assumed target velocity range” in the middle part of FIG. 6 literally represents a range of possible velocities of the target (Tgt) that is assumed in advance. The minimum value (Nₘᵢₙ) and the maximum value (Nₘₐₓ) for n in Expression (1) are determined from the range of possible velocities of the target (Tgt) that is assumed in advance.

The lower part of FIG. 6 illustrates a state in which the Doppler bin number (described as “number of velocity bin” in FIG. 6) is redefined for a new range-velocity map (M_{rd1}) obtained by the connection. The Doppler bin numbers (n_{d}) are arranged as 1, 2, . . . , and N_{d1} in ascending order of the velocity.

The new range-velocity map (M_{rd1}) created by the range-velocity map generating unit 740-1 in the LPRF system is sent to the interpolation processing unit 750.

### <<Range-Velocity Map Generating Unit 740-2 in HPRF System Included in Signal Processing System 700>>

The range-velocity map generating unit 740-2 in the HPRF system included in the signal processing system 700 is a component that generates a range-velocity map. The range-velocity map generating unit 740-2 in the HPRF system considers ambiguity (hereinafter, referred to as “range ambiguity (r_{amb})”) of distance (also referred to as range) when generating the range-velocity map.

Assuming that the distance of the target (Tgt) related to a target signal of the nᵣth range bin is r₂(nᵣ), the ghost including the range ambiguity (r_{amb}) can be any r₂ expressed by the following expression in principle.

$${r}_{2} = \overline{{r}_{2}} ( {n}_{r} ) + {nr}_{amb} \qquad ( 2 )$$

$$wherein {r}_{amb} = \frac{{cT}_{HPRI}}{2}$$

Here, n is an integer. In Expression (2), c represents the speed of light, and T_{HPRI} represents the pulse repetition period of the HPRF pulse. The horizontal bar of the accent symbol used in Expression (2) indicates a value related to a real image that does not include ambiguity. From another point of view, Expression (2) represents that the range ambiguity (r_{amb}) regularly occurs. Note that the detail of the ghost represented in Expression (2) will be apparent from the description of FIGS. 10 and 12 described later.

The range-velocity map generating unit 740-2 in the HPRF system performs processing of connecting the range-velocity maps in consideration of the range ambiguity (r_{amb}).

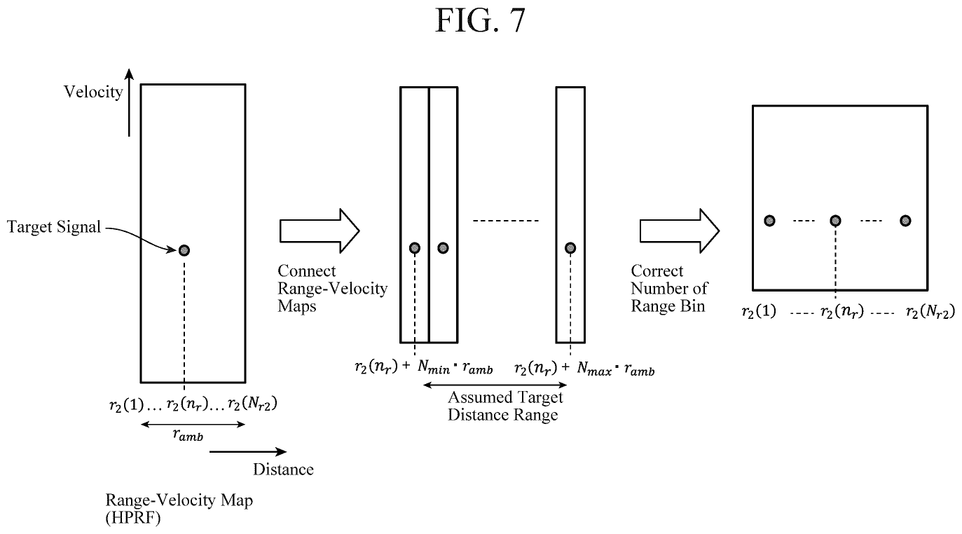

FIG. 7 is an explanatory diagram illustrating the detail of the processing performed by the range-velocity map generating unit 740-2 in the radar apparatus according to the first embodiment.

The left column of FIG. 7 illustrates that the range bin (nᵣ, 1 to Nᵣ₂) is set in consideration of the magnitude of the range ambiguity (r_{amb}).

The middle column of FIG. 7 illustrates a state in which the range-velocity map generating unit 740-2 in the HPRF system connects the range-velocity maps. A line segment with a double-headed arrow having a description of “assumed target distance range” in the middle column of FIG. 7 literally represents a range of possible distances (ranges) of the target (Tgt) that is assumed in advance. The minimum value (Nₘᵢₙ) and the maximum value (Nₘₐₓ) for n in Expression (2) are determined from the range of possible distances (ranges) of the target (Tgt) that is assumed in advance.

The right column of FIG. 7 illustrates a state in which the range bin number (described as “number of range bin” in FIG. 7) is redefined for a new range-velocity map (M_{rd2}) obtained by the connection. The range bin numbers (nᵣ) are arranged as 1, 2, . . . and Nᵣ₂ in ascending order of the distance.

The new range-velocity map (M_{rd2}) created by the range-velocity map generating unit 740-2 in the HPRF system is sent to the interpolation processing unit 750.

### <<Interpolation Processing Unit 750 Included in Signal Processing System 700>>

The interpolation processing unit 750 included in the signal processing system 700 is a component that performs processing of interpolating and correcting the range bin and the Doppler bin in the range-velocity map in consideration of information obtained by the LPRF system and information obtained by the HPRF system.

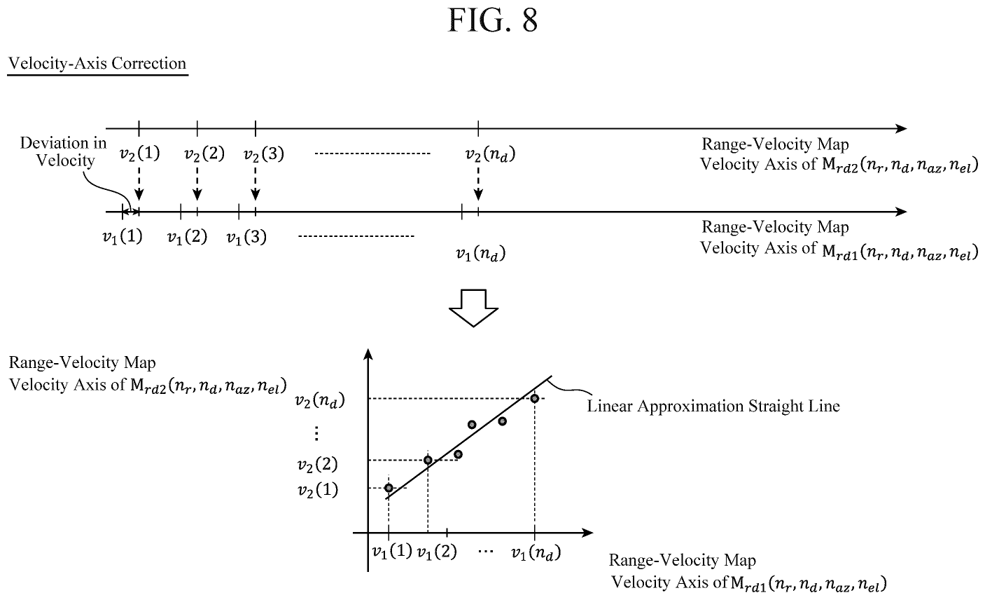

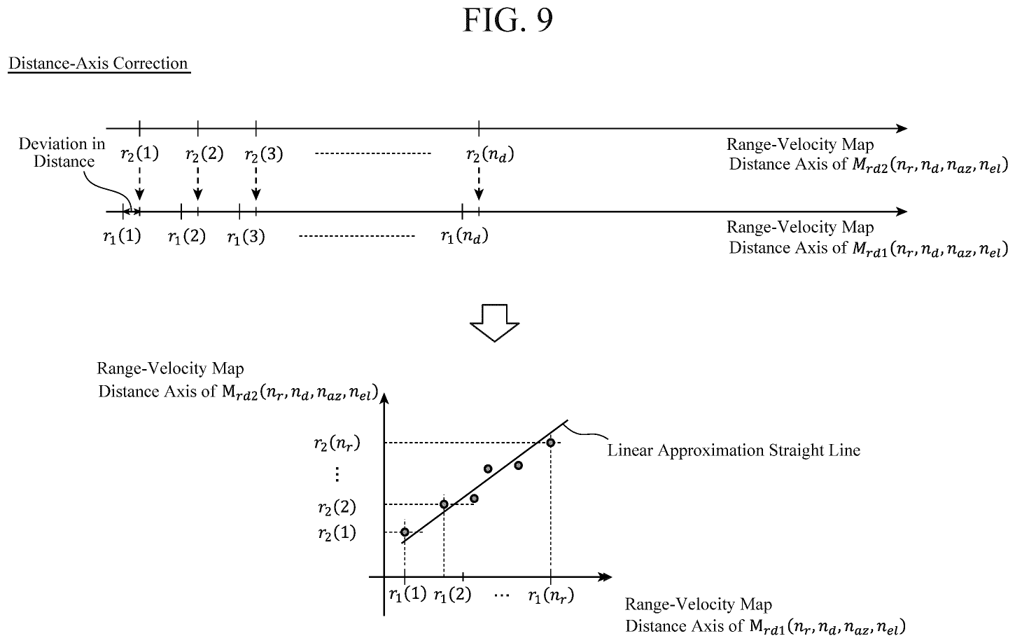

FIG. 8 is an explanatory diagram illustrating velocity-axis correction that is the detail of processing performed by the interpolation processing unit 750 in the radar apparatus according to the first embodiment. FIG. 9 is an explanatory diagram illustrating distance-axis correction that is the detail of processing performed by the interpolation processing unit 750 in the radar apparatus according to the first embodiment.

The upper part of FIG. 8 illustrates that a difference in Doppler bin may occur between the new range-velocity map (M_{rd1}) created by the range-velocity map generating unit 740-1 of the LPRF system and the new range-velocity map (Mac) created by the range-velocity map generating unit 740-2 of the HPRF system.

In the lower part of FIG. 8, the horizontal axis represents the Doppler bin of the range-velocity map (M_{rd1}) created in the LPRF system, the vertical axis represents the Doppler bin of the range-velocity map (M_{rd2}) created in the HPRF system, and the correlation between them is represented by plots. A straight line described as a “linear approximation straight line” in the lower part of FIG. 8 indicates that there is a correlation that can be approximated linearly between the Doppler bin of the range-velocity map (M_{rd1}) created in the LPRF system and the Doppler bin of the range-velocity map (M_{rd2}) created in the HPRF system.

The interpolation processing unit 750 included in the signal processing system 700 can appropriately interpolate and correct the Doppler bin in the range-velocity map with the correlation represented by the linear approximation straight line as positive.

The upper part of FIG. 9 illustrates that a difference in range bin may occur between the new range-velocity map (M_{rd1}) created by the range-velocity map generating unit 740-1 of the LPRF system and the new range-velocity map (M_{rd2}) created by the range-velocity map generating unit 740-2 of the HPRF system.

In the lower part of FIG. 9, the horizontal axis represents the range bin of the range-velocity map (M_{rd1}) created in the LPRF system, the vertical axis represents the range bin of the range-velocity map (M_{rd2}) created in the HPRF system, and the correlation between them is represented by plots. A straight line described as a “linear approximation straight line” in the lower part of FIG. 9 indicates that there is a correlation that can be approximated linearly between the range bin of the range-velocity map (M_{rd1}) created in the LPRF system and the range bin of the range-velocity map (M_{rd2}) created in the HPRF system.

The interpolation processing unit 750 included in the signal processing system 700 can appropriately interpolate and correct the range bin in the range-velocity map with the correlation represented by the linear approximation straight line as positive.

The range-velocity map interpolated and corrected by the interpolation processing unit 750 is sent to the integration processing unit 760.

### <<Integration Processing Unit 760 Included in Signal Processing System 700>>

In a technical field related to signal processing of a radar apparatus, integration processing is often used for the purpose of improving an SN ratio. The integration processing unit 760 included in the signal processing system 700 is a component that performs integration processing for improving the SN ratio.

As described above, the integration processing unit 760 according to the first embodiment performs the PDI on the range-velocity map. In the present specification, the rang-velocity map on which the PDI is performed is referred to as PDI signal (p_{rd}), and is distinguished from the range-velocity map that has not yet been subjected to the PDI. The PDI signal (p_{rd}) can also be considered as a function using nᵣ, n_{d}, n_{az}, and nₑₗ as arguments. The PDI signal (p_{rd}) is given by, for example, the following expression.

$${p}_{rd} ( {n}_{r} , {n}_{d} , {n}_{az} , {n}_{el} ) = \sum {M}_{rd 1} ( {n}_{r} , {n}_{d} , {n}_{az} , {n}_{el} ) + \sum {M}_{rd 2} ( {n}_{r} , {n}_{d} , {n}_{az} , {n}_{el} ) OR \qquad ( 3 )$$

$${p}_{rd} ( {n}_{r} , {n}_{d} , {n}_{az} , {n}_{el} ) = {\vert {M}_{rd 1} ( {n}_{r} , {n}_{d} , {n}_{az} , {n}_{el} ) \vert}^{2} + {\vert {M}_{rd 2} ( {n}_{r} , {n}_{d} , {n}_{az} , {n}_{el} ) \vert}^{2}$$

Here, in the lower part of Expression (3), the PDI signal (p_{rd}) is calculated on the basis of the relationship indicating that the square of the signal amplitude represents power.

The PDI signal (p_{rd) generated by the integration processing unit 760 is transmitted to the comparison processing unit 770.}

### <<Comparison Processing Unit 770 Included in Signal Processing System 700>>

The comparison processing unit 770 included in the signal processing system 700 is a component that compares the component of the signal (the PDI signal (p_{rd}) in the first embodiment) subjected to the integration processing by the integration processing unit 760 with a preset threshold value (also referred to as a threshold) and determines whether the signal is a target signal or an unnecessary signal for the target (Tgt).

The comparison processing unit 770 numbers the components of the PDI signal (p_{rd}) exceeding the threshold value in the detection order. In the comparison processing unit 770, the component of the PDI signal (p_{rd}) exceeding the threshold value is sent to the target detection processing unit 3000 as a candidate of the target signal.

As described above, the PDI signal (p_{rd}) can be considered as a function using nᵣ, n_{d}, n_{az}, and nₑₗ as arguments. During the detection of the target (Tgt), information indicating what nᵣ, n_{d}, n_{az}, and nₑₗ are when the PDI signal (p_{rd}) exceeds the threshold value is important. Therefore, the comparison processing unit 770 records nᵣ, n_{d}, n_{az}, and nₑₗ when the PDI signal (p_{rd}) exceeds the threshold value as, for example, a structure.

The signal processing system 700 (1-700) in the LPRF radar device 1000 may define a structure (X₁) as follows, for example.

$$for {k}_{1} = 1 to {K}_{1} \qquad ( 4 )$$

$${X}_{1} ( {k}_{1} ) := \{ \begin{matrix}{k}_{1}^{th} {n}_{r} of {p}_{rd} which exceeded threshold \\ {k}_{1}^{th} {n}_{d} of {p}_{rd} which exceeded threshold \\ {k}_{1}^{th} {n}_{az} of {p}_{rd} which exceeded threshold \\ {k}_{1}^{th} {n}_{el} of {p}_{rd} which exceeded threshold\end{matrix} \}$$

Here, k₁ is a variable used in the signal processing system 700 (1-700), and K₁ is the total number of the components of the PDI signal (Pra) exceeding the threshold value in the signal processing system 700 (1-700). The element (also referred to as field) of the structure (X₁) may have a value of the k₁th p_{rd} that exceeds the threshold value in addition to those represented in Expression (4).

The information about the structure (X₁) obtained by the signal processing system 700 (1-700) is transmitted to the target detection processing unit 3000 together with the information about the PDI signal (p_{rd}).

Similarly, the signal processing system 700 (2-700) in the HPRF radar device 2000 may define a structure (X₂) as follows, for example.

$$for {k}_{2} = 1 to {K}_{2} \qquad ( 5 )$$

$${X}_{2} ( {k}_{2} ) := \{ \begin{matrix}{k}_{2}^{th} {n}_{r} of {p}_{rd} which exceeded threshold \\ {k}_{2}^{th} {n}_{d} of {p}_{rd} which exceeded threshold \\ {k}_{2}^{th} {n}_{az} of {p}_{rd} which exceeded threshold \\ {k}_{2}^{th} {n}_{el} of {p}_{rd} which exceeded threshold\end{matrix} \}$$

Here, k₂ is a variable used in the signal processing system 700 (2-700), and K₂ is the total number of the components of the PDI signal (p_{rd}) exceeding the threshold value in the signal processing system 700 (2-700). The element (also referred to as field) of the structure (X₂) may have a value of the k₂th p_{rd} that exceeds the threshold value in addition to those represented in Expression (5).

The information about the structure (X₂) obtained by the signal processing system 700 (2-700) is transmitted to the target detection processing unit 3000 together with the information about the PDI signal (p_{rd}).

### <<Target Detection Processing Unit 3000>>

The target detection processing unit 3000 is a component that detects the target (Tgt) on the basis of the information transmitted from the signal processing system 700 (1-700) of the LPRF radar device 1000 and the information transmitted from the signal processing system 700 (2-700) of the HPRF radar device 2000.

The processing performed by the target detection processing unit 3000 is considered to be roughly divided into two processes. One of them is checking of the correspondence. The other is a process called “detection of one out of two”.

The checking of the correspondence relationship performed by the target detection processing unit 3000 means processing of comparing information about the structure (X₁) transmitted from the signal processing system 700 (1-700) in the LPRF radar device 1000 with information about the structure (X₂) transmitted from the signal processing system 700 (2-700) in the HPRF radar device 2000, and checking the correspondence relationship indicating in which record a certain same target (Tgt) appears in each structure.

For example, it is assumed that, when the 10th record (X₁(10)) (k₁=10) of the structure (X₁) and the 12th record (X₂(12)) (k₂=12) of the structure (X₂) are compared with each other, the four elements (nᵣ, n_{d}, n_{az}, and nₑₗ) of the respective records are substantially the same. At this time, the target detection processing unit 3000 determines that the 10th record (k₁=10) of the structure (X₁) and the 12th record (k₂=12) of the structure (X₂) are for a certain same target (Tgt) and associates them with each other.

In a case where the target (Tgt) that is an object to be detected is sufficiently far away with respect to the distance between the LPRF radar device 1000 and the HPRF radar device 2000, there is a tendency that the information about the structure (X₁) and information about the structure (X₂) are substantially the same.

The checking of the correspondence relationship performed by the target detection processing unit 3000 may be performed in combination with the tracking function of the radar apparatus.

The process of “detection of one out of two” performed by the target detection processing unit 3000 means that processing is performed in such a way that a target (Tgt) detected by only one of the two radar devices, the LPRF radar device 1000 and the HPRF radar device 2000, can also be output as a detection result. Specifically, the target detection processing unit 3000 connects the structure (X₁) and the structure (X₂) as a union. The structure formed by the connection is referred to as X_{ADD} herein. In the example described above, the 10th record (k₁=10) of the structure (X₁) and the 12th record (k₂=12) of the structure (X₂) are for a certain same target (Tgt). In this case, in the structure (X_{ADD}) obtained by the process of “detection of one out of two”, the records for this certain same target (Tgt) are grouped into one.

In this manner, the target detection processing unit 3000 performs the checking of the correspondence and the process of “detection of one out of two” to generate the structure (X_{ADD}). The structure (X_{ADD}) generated by the target detection processing unit 3000 includes information about the target (Tgt) detected by only one of the two radar devices, the LPRF radar device 1000 and the HPRF radar device 2000.

FIG. 10 is a diagram illustrating an example of the range-velocity map obtained by the radar apparatus according to the present disclosure. When a record having a set of n_{az} and nₑₗ which are the same is extracted in the structure (X_{ADD}) generated by the target detection processing unit 3000 and points of (nᵣ, n_{d}) are plotted, the range-velocity map illustrated in FIG. 10 is obtained. The range-velocity map illustrated in FIG. 10 is the one when a certain target (Tgt) is assumed. The radar apparatus according to the present disclosure can group a plurality of plots appearing in the range-velocity map as being derived from a certain target (Tgt) by using the information about the velocity ambiguity (V_{amb}) indicated by Expression (1) and the information about the range ambiguity (r_{amb}) indicated by Expression (2). This grouping processing is performed by the target detection processing unit 3000.

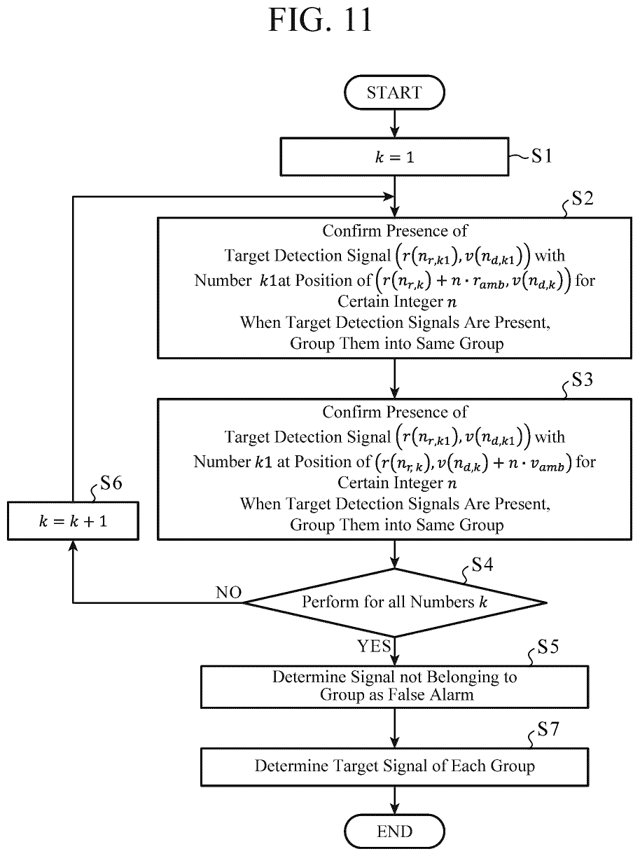

FIG. 11 is a flowchart illustrating a procedure of the grouping processing performed by the target detection processing unit 3000 in the radar apparatus according to the first embodiment. FIG. 12 is an explanatory diagram illustrating the procedure of the grouping processing performed by the target detection processing unit 3000 in the radar apparatus according to the first embodiment.

A step denoted by S1 in FIG. 11 is a processing step of initializing the variable (k) used in the grouping processing. In S1, an initial value of 1 is substituted for the variable (k).

When the processing is at the stage of step S1, the range-velocity map is in a state illustrated in FIG. 12A. In the case illustrated in FIG. 12A, there are 16 plots exceeding the threshold value in the range-velocity map.

A step denoted by S2 in FIG. 11 is a processing step of performing grouping in the distance direction on the basis of the information about the range ambiguity (r_{amb}). In S2, the target detection processing unit 3000 checks whether or not there are other plots at positions of integral multiples of the range ambiguity (r_{amb}) in the direction of the distance around the kth plot.

The processing content of S2 can be described with the range-velocity map illustrated in FIG. 12B. In S2, the target detection processing unit 3000 checks whether or not there are other plots at positions of integral multiples of the range ambiguity (r_{amb}) in the direction of the distance around the eighth plot (k=8). In the range-velocity map illustrated in FIG. 12B, the sixth plot (k=6), the seventh plot (k=7), and the ninth plot (k=9) are at the positions of integral multiples of the range ambiguity (r_{amb}) in the distance direction, and thus, these plots are grouped.

A step denoted by S3 in FIG. 11 is a processing step of performing grouping in the velocity direction on the basis of the information about the velocity ambiguity (V_{amb}). In S3, the target detection processing unit 3000 checks whether or not there are other plots at positions of integral multiples of the velocity ambiguity (V_{amb}) in the direction of the velocity around the kth plot.

The processing content of S3 can be described with the range-velocity map illustrated in FIG. 12B. In S3, the target detection processing unit 3000 checks whether or not there are other plots at positions of integral multiples of the velocity ambiguity (V_{amb}) in the direction of the velocity around the eighth plot (k=8). In the range-velocity map illustrated in FIG. 12B, the first plot (k=1), the fourth plot (k=4), and the sixteenth plot (k=16) are at the positions of integral multiples of the velocity ambiguity (V_{amb}) in the velocity direction, and thus, these plots are grouped.

A step denoted by S4 in FIG. 11 is a processing step of checking whether the processes of steps S2 and S3 have been performed for all k, that is, all plots.

When the processes of steps S2 and S3 have not yet been performed for all plots, i.e., NO in S4, the processing proceeds to S6. In S6, an incrementing process (operation of adding 1 to a numerical value) is performed on the variable (k) used here. Thereafter, the processing proceeds to S2 in the second and subsequent cycles. The processing contents of S2 and S3 in the second and subsequent cycles can be described with the range-velocity map illustrated in FIG. 12C. In S2 and S3 in the second cycle, the target detection processing unit 3000 groups plots of k=3, 5, 10, 11, 12, 13, and 15 around the eleventh plot (k=11) as another group.

When the processes of steps S2 and S3 have been performed for all plots, i.e., YES in S4, the processing proceeds to S5.

The step denoted by S5 in FIG. 11 relates to the procedure on the ungrouped plots. In S5, the target detection processing unit 3000 determines that a plot not belonging to any group is noise and false alarm.

The processing content of S5 can be described with the range-velocity map illustrated in FIG. 12C. In S5, the target detection processing unit 3000 determines that a plot not belonging to any group, that is, the plots of k=2 and 14, is noise and false alarm.

A step denoted by S7 in FIG. 11 is a processing step of excluding a so-called virtual image plot (also referred to as ghost) including ambiguity and finding a so-called real image plot not including ambiguity for each group.

In general, the signal intensity according to the real image plot is higher than the signal intensity according to the virtual image plot. Therefore, it is conceivable to find a real image plot from each group on the basis of the information about the signal intensity.

The processing content of S7 can be described with the range-velocity maps illustrated in FIGS. 12C and 12D. In the case illustrated in FIG. 12, the real image plot of the group grouped in the first cycle of the processing is the eighth (k=8) plot, and the real image plot of the group grouped in the second cycle of the processing is the eleventh (k=11) plot. The eighth (k=8) plot and the eleventh (k=11) plot are plots located at intersections of crosses grouped in a cross shape, respectively. When the virtual image plots appear in a cross shape with the real image plot as the center as in the case illustrated in FIG. 12, the plot located at the intersection of the cross can be estimated as the real image plot. It is to be noted, however, that it is also conceivable that the range ambiguity (r_{amb}) and the velocity ambiguity (V_{amb}) simultaneously occur. When the range ambiguity (r_{amb}) and the velocity ambiguity (V_{amb}) occur simultaneously, the virtual image plots appear in a lattice pattern in the range-velocity map.

As described above, the radar apparatus according to the first embodiment has the above configuration, and thus, can detect the target (Tgt) using a plurality of radio waves having different PRFs, and can achieve detection of the target (Tgt) resistant to noise based on various types of information as compared with the conventional radar apparatus.

### Second Embodiment

A radar apparatus according to a second embodiment is a modification of the radar apparatus according to the present disclosure. Unless otherwise specified, the same reference signs as those used in the first embodiment are used in the second embodiment. In addition, in the second embodiment, the description overlapping with that of the first embodiment is appropriately omitted.

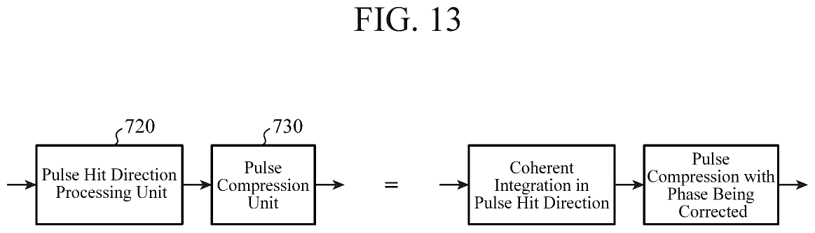

FIG. 13 is an explanatory diagram illustrating a mode of a partial functional block in the radar apparatus according to the second embodiment. More specifically, FIG. 13 is an explanatory diagram illustrating modes of a pulse hit direction processing unit 720 and a pulse compression unit 730 in the radar apparatus according to the second embodiment. As illustrated in FIG. 13, in the radar apparatus according to the second embodiment, the pulse hit direction processing unit 720 performs coherent integration in a pulse hit direction, and the pulse compression unit 730 performs phase correction and pulse compression.

The radar apparatus according to the second embodiment is based on the premise that the velocity of a target (Tgt) can be assumed in advance. The velocity of the target (Tgt) assumed in advance is given as a set of velocities (v_{c}) by the following expression using symbols.

$${v}_{c} := \{ {v}_{c , 1} , {v}_{c , 2} , … , {v}_{c , {N}_{d}} \} \qquad ( 6 )$$

Here, N_{d} appearing as the subscript in the right side of Expression (6) is the possible maximum value of the Doppler bin number (n_{d}) appearing in Expression (1), and is the total number of Doppler bins. In other words, the radar apparatus according to the second embodiment assumes the velocities of the target (Tgt) in advance by the total number of Doppler bins.

### <<Pulse Hit Direction Processing Unit 720 According to Second Embodiment>>

The pulse hit direction processing unit 720 according to the second embodiment corrects the phase rotation of a signal by the Doppler frequency using the set of velocities (v_{c}) of the target (Tgt) assumed in advance, and then performs coherent integration in the pulse hit direction. Note that the pulse hit direction processing unit 720 includes the pulse hit direction processing unit (720-1) in the LPRF system and the pulse hit direction processing unit (720-2) in the HPRF system, and the pulse hit direction processing unit 720 performs the same processing content in both systems.

The processing performed by the pulse hit direction processing unit 720 according to the second embodiment is given by, for example, the following expression.

$$for {n}_{d} = 1 to {N}_{d} \qquad ( 7 )$$

$${s}_{f} ( {n}_{d} ) := {\sum }_{{n}_{h} = 1}^{{N}_{h}} {s}_{j} ( {t}_{{n}_{b}} ) exp ( - j 2 π \frac{2 {v}_{c , {n}_{d}}}{c} {f}_{s} {t}_{{n}_{h}} )$$

Here, Sⱼ on the right side of Expression (7) is a signal transmitted from an AD converter 710, and Sf on the left side of Expression (7) is a signal (hereinafter, referred to as “coherent integration signal (S_{f})”) obtained by the processing performed by the pulse hit direction processing unit 720. In Expression (7), nₕ is a variable (pulse hit number) that is a natural number from 1 to Nₕ, and Nₕ is the total number of discrete-time signal sequences transmitted from the AD converter 710. t with a subscript nₕ represents time at the nₕth sampling. In Expression (7), fₛ is a transmission frequency. In the pulse hit direction processing unit 720 (720-1) in the LPRF system, fₛ is f₁ appearing in Expression (1).

Note that the pulse hit direction processing unit 720 performs the processing represented by Expression (7) for all combinations of n_{az} and nₑₗ.

In a case where there is a missing part in the data, the pulse hit direction processing unit 720 according to the second embodiment may appropriately fill the missing part with a determined value such as an average value, a median value, or 0.

The coherent integration signal (S_{f}) generated by the pulse hit direction processing unit 720 according to the second embodiment is sent to the pulse compression unit 730.

### <<Pulse Compression Unit 730 According to Second Embodiment>>

The pulse compression unit 730 according to the second embodiment corrects a frequency shift in the power spectrum of a target signal due to Doppler and performs pulse compression. The correction of the frequency shift performed by the pulse compression unit 730 according to the second embodiment is given by, for example, the following expression.

$${s}_{f}^{′} ( {n}_{d} ) = {s}_{f} ( {n}_{d} ) exp ( - j 2 π \frac{2 {v}_{c , {n}_{d}}}{c} {f}_{s} {t}_{{n}_{h} , 1} ) \qquad ( 8 )$$

The signal (s′_{f}) whose phase has been corrected by the pulse compression unit 730 according to the second embodiment is sent to a range-velocity map generating unit 740. The subsequent processing is similar to that described in the first embodiment.

As described above, the radar apparatus according to the second embodiment has the above configuration, and thus, can correct the phase rotation caused by Doppler. With this effect, the radar apparatus according to the second embodiment has an effect of reducing an integration loss in pulse compression in addition to the effect described in the first embodiment.

### Third Embodiment

A radar apparatus according to a third embodiment is a modification of the radar apparatus according to the present disclosure. Unless otherwise specified, the same reference signs as those used in the previously described embodiments are used in the third embodiment. In addition, in the third embodiment, the description overlapping with those of the previously described embodiments is appropriately omitted.

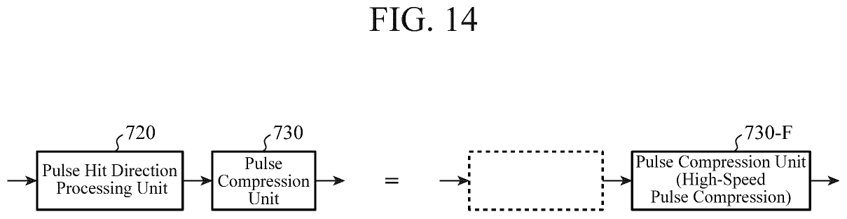

FIG. 14 is an explanatory diagram illustrating a mode of a partial functional block in the radar apparatus according to the third embodiment. As illustrated in FIG. 14, it is also conceivable that, in the radar apparatus according to the present disclosure, the functions of the pulse hit direction processing unit 720 and the pulse compression unit 730 are replaced with a pulse compression unit 730-F that performs high-speed pulse compression.

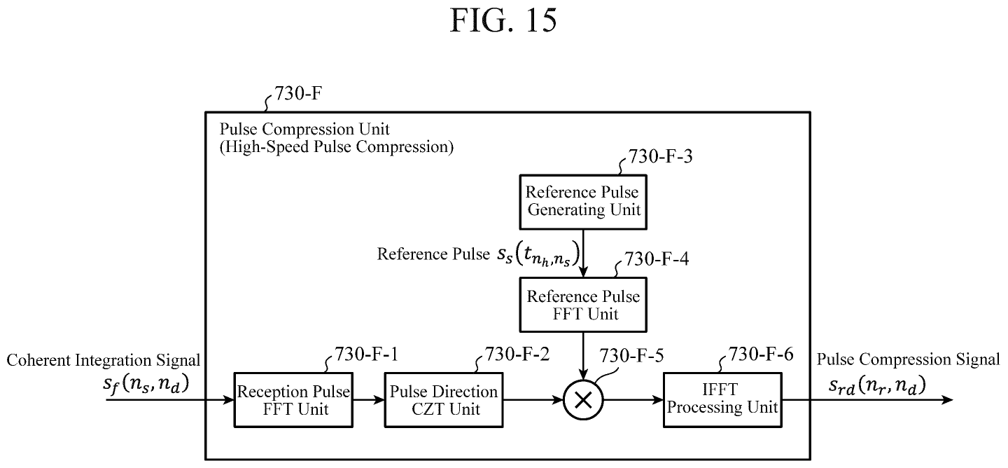

FIG. 15 is a block diagram illustrating a detailed functional configuration of the pulse compression unit 730-F in the radar apparatus according to the third embodiment. As illustrated in FIG. 15, the pulse compression unit 730-F according to the third embodiment includes a reception pulse FFT unit 730-F-1, a pulse direction CZT unit 730-F-2, a reference pulse generating unit 730-F-3, a reference pulse FFT unit 730-F-4, a multiplication unit 730-F-5, and an IFFT processing unit 730-F-6.

### <<Reception Pulse FFT Unit 730-F-1 Included in Pulse Compression Unit 730-F>>

The reception pulse FFT unit 730-F-1 included in the pulse compression unit 730-F is a component for performing FFT (hereinafter referred to as “range FFT”) in the distance direction. The range FFT performed by the reception pulse FFT unit 730-F-1 is given by the following expression.

$$[ {s}_{fj} ( {n}_{r} , {n}_{h} ) \} = \{ {s}_{fj} ( 1 , {n}_{h} ) , {s}_{fj} ( 2 , {n}_{h} ) , … , {s}_{fj} ( {n}_{r} , {n}_{h} ) , … , {s}_{fj} ( {N}_{r} , {n}_{h} ) \} \qquad ( 9 )$$

$$wherein [ {s}_{fj} ( {n}_{r} , {n}_{h} ) \} := {Range}_{} [ {s}_{j} ( {t}_{{n}_{h}} ) ]$$

Here, the conversion into F expressed in a script typeface with a subscript “Range” represents a range FFT. In Expression (9), sⱼ is the same as that appearing in Expression (7), and represents a signal transmitted from the AD converter 710. In Expression (9), nₕ is the same as that appearing in Expression (7), and is a variable (pulse hit number) that is a natural number from 1 to Nₕ. Note that the reception pulse FFT unit 730-F-1 performs the range FFT represented by Expression (9) for all combinations of n_{az} and nₑₗ.

The signal (S_{fj}) obtained by the range FFT by the reception pulse FFT unit 730-F-1 is sent to the pulse direction CZT unit 730-F-2.

### <<Pulse Direction CZT Unit 730-F-2 Included in Pulse Compression Unit 730-F>>

The pulse direction CZT unit 730-F-2 included in the pulse compression unit 730-F is a component that performs chirp z-transform in the pulse hit direction. The character CZT included in the name of the pulse direction CZT unit 730-F-2 is an acronym for Chirp Z-Transform which means chirp z-transform. The chirp z-transform enables execution of a high-speed convolution operation.

The details of the chirp z-transform performed by the pulse direction CZT unit 730-F-2 is apparent by introducing the following variables (f and g).

$$f ( {n}_{r} , {n}_{h} ) := {s}_{fj} ( {n}_{r} , {n}_{h} ) {A}^{- {n}_{h}} {W}^{\frac{{( {n}_{h} )}^{2}}{2}} \qquad ( 10 )$$

$$g ( {n}_{h} ) := {W}^{\frac{- {( {n}_{h} )}^{2}}{2}} \qquad ( 11 )$$

Note that A appearing in Expression (10) and W appearing in Expressions (10) and (11) are given as follows.

$$A := exp ( j 2 π \frac{2 {v}_{c , 1}}{c} {f}_{a} {T}_{s} ) \qquad ( 12 )$$

$$W := exp ( - j 2 π \frac{2 {v}_{c}}{c} {f}_{a} {T}_{h} ) \qquad ( 13 )$$

Here, A given by Expression (12) and W given by Expression (13) are variables used in the chirp z-transform. It is assumed that Δv_{c} appearing in Expression (13) is a difference between adjacent velocities in the set of velocities (v_{c}) in Expression (6) defined as the velocity of the target (Tgt) assumed in advance. That is, in the third embodiment, it is assumed that the velocity (V_{c, 1}, V_{c,2}, . . . , V_{c,Nd}) of the target (Tgt) assumed in advance is an arithmetic progression with Δv_{c} as a difference. In Expressions (12) and (13), fₐ is a frequency obtained by adding a distance-dependent frequency (beat frequency in the case of using chirp modulation, and the like) to the transmission frequency. In Expression (12), Tₛ represents a sampling period, and in Expression (13), Tₕ represents a pulse hit interval.

The pulse direction CZT unit 730-F-2 performs FFT processing on f given by Expression (10) and g given by Expression (11). Functions F and G obtained by the FFT processing can be expressed as follows.

$$f ( {n}_{r} , {n}_{d} ) = [ f ( {n}_{r} , {n}_{h} ) ] \qquad ( 14 )$$

$$G ( {n}_{d} ) = [ g ( {n}_{h} ) ] \qquad ( 15 )$$

In Expressions (14) and (15), F expressed in a script typeface represents Fourier transform, that is, FFT.

Note that, in the radar apparatus according to the second embodiment described above, Expression (7) related to the processing performed by the pulse hit direction processing unit 720 indicates the relationship between the pulse hit number (nₕ) and the Doppler bin number (n_{d}). In the radar apparatus according to the third embodiment in which the pulse hit direction processing unit 720 is omitted, the relationship between the pulse hit number (nₕ) and the Doppler bin number (n_{d}) is indicated by Expressions (14) and (15) related to the Fourier transform. Due to the nature of FFT, N_{d} has a value equal to Nₕ.

The pulse direction CZT unit 730-F-2 finally calculates a value (s′_{f2}) given by the following expression.

$${s}_{f 2}^{′} ( {n}_{r} , {n}_{d} ) := {W}^{\frac{{( {n}_{h} )}^{2}}{2}} F ( {n}_{r} , {n}_{d} ) G ( {n}_{d} ) \qquad ( 16 )$$

Expression (16) according to the third embodiment corresponds to Expression (8) (expression from which s′_{f} is derived) according to the second embodiment described above.

S′_{f2} calculated by the pulse direction CZT unit 730-F-2 is sent to the multiplication unit 730-F-5.

### <<Reference Pulse Generating Unit 730-F-3 Included in Pulse Compression Unit 730-F>>

The reference pulse generating unit 730-F-3 included in the pulse compression unit 730-F is a component that generates a reference pulse (sₛ) used for the pulse compression processing. The sampling number associated with the reference pulse (sₛ) is represented by nₛ. nₛ is a natural number from 1 to Nₛ. The reference pulse (sₛ) is given by a function using the nₛth sampling time (tₙₛ) as an argument.

### <<Reference Pulse FFT Unit 730-F-4 Included in Pulse Compression Unit 730-F>>

The reference pulse FFT unit 730-F-4 included in the pulse compression unit 730-F is a component that literally executes FFT on the reference pulse (sₛ).

Before performing FFT, the reference pulse FFT unit 730-F-4 may perform, for example, correction given by the following expression, that is, correction of phase rotation by Doppler.

$${s}_{s}^{′} ( {t}_{{n}_{s}} ) := {s}_{s} ( {t}_{{n}_{s}} ) exp ( - j 2 π \frac{2 ( {n}_{d} - 1 ) Δ {v}_{c}}{c} {f}_{s} ( {n}_{s} - 1 ) {T}_{s} ) \qquad ( 17 )$$

$$wherein , Radial velocity is ( {n}_{d} - 1 ) Δ {v}_{c}$$

Here, Tₛ is a sampling period related to the reference pulse (sₛ).

The signal sequence (hereinafter, referred to as “FFT output signal sequence”) subjected to the FFT processing by the reference pulse FFT unit 730-F-4 can be expressed as follows.

$$FFT output signal sequence \{ {s}_{sf}^{′} ( {n}_{r} ) \} = \{ {s}_{sf}^{′} ( 1 ) , {s}_{sf}^{′} ( 2 ) , … , {s}_{sf}^{′} ( {n}_{r} ) , … , {s}_{sf}^{′} ( {N}_{r} ) \} wherein \qquad ( 18 )$$

$$\{ {s}_{sf}^{′} ( {n}_{r} ) \} = \{ {s}_{s}^{′} ( {t}_{{n}_{s}} ) \}$$

The curly brackets used in Expression (18) indicate a signal sequence. Due to the nature of FFT, Nᵣ has a value equal to Nₛ.

The FFT output signal sequence generated by the reference pulse FFT unit 730-F-4 is transmitted to the multiplication unit 730-F-5.

### <<Multiplication Unit 730-F-5 Included in Pulse Compression Unit 730-F>>

The multiplication unit 730-F-5 included in the pulse compression unit 730-F is a component that multiplies the signal (s′_{f2}) from the pulse direction CZT unit 730-F-2 by the signal (s′_{sf}) from the reference pulse FFT unit 730-F-4. Specifically, the multiplication unit 730-F-5 performs multiplication processing described below.

$${s}_{sf 2} ( {n}_{r} , {n}_{d} ) = {{s}_{sf}^{′} ( {n}_{r} , {n}_{d} ) [ {s}_{sf}^{′} ( {n}_{r} ) ]}^{*} \qquad ( 19 )$$

Here, the asterisk as the superscript appearing on the right side of Expression (19) represents a complex conjugate.

### <<IFFT Processing Unit 730-F-6 Included in Pulse Compression Unit 730-F>>

The IFFT processing unit 730-F-6 included in the pulse compression unit 730-F is a component that performs inverse Fourier transform. The IFFT in the name of the IFFT processing unit 730-F-6 is an acronym for Inverse Fast Fourier Transform which means inverse fast Fourier transform.

In the radar apparatus according to the third embodiment, processing performed in the stage subsequent to the pulse compression unit 730-F is the same as the processing of the radar apparatuses according to the previously described embodiments.

As described above, the radar apparatus according to the third embodiment has the above configuration, and thus, can perform CZT processing. With this effect, the radar apparatus according to the third embodiment can perform the convolution operation at high speed and correct the phase rotation due to Doppler, in addition to the effect described in the first embodiment.

### Fourth Embodiment

A radar apparatus according to a fourth embodiment is a modification of the radar apparatus according to the present disclosure. Unless otherwise specified, the same reference signs as those used in the previously described embodiments are used in the fourth embodiment. In addition, in the fourth embodiment, the description overlapping with those of the previously described embodiments is appropriately omitted.

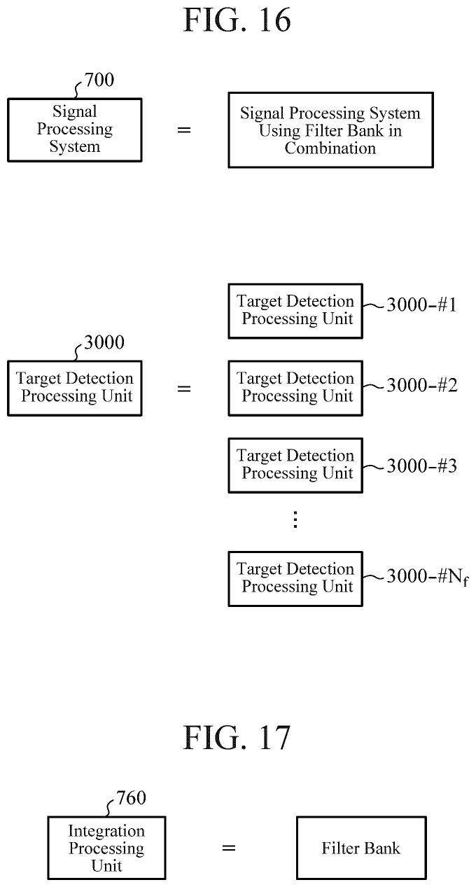

FIG. 16 is a first explanatory diagram illustrating a mode of a partial functional block in the radar apparatus according to the fourth embodiment. As illustrated in the upper part of FIG. 16, a signal processing system 700 according to the present disclosure may perform signal processing using a filter bank in combination. The filter bank is an array of bandpass filters, and is a circuit that divides an input signal into a plurality of components. As illustrated in the lower part of FIG. 16, a target detection processing unit 3000 according to the present disclosure may include N_{f} independent target detection processing units 3000 (3000-#1, 3000-#2, . . . , 3000-#N_{f}). N_{f} is the total number of bandpass filters in the filter bank. When n_{f} (n_{f} is a natural number of 1, 2, . . . , N_{f}) is the identification number of the bandpass filter in the filter bank, the signal component that has passed through the n_{f}th bandpass filter is sent to the corresponding target detection processing unit 3000-#n_{f} in both the LPRF system and the HPRF system of the signal processing system 700.

FIG. 17 is a second explanatory diagram illustrating a mode of a partial functional block in the radar apparatus according to the fourth embodiment. As illustrated in FIG. 17, the filter bank included in the signal processing system 700 may be implemented by, for example, an integration processing unit 760 in the signal processing system 700.

### <<Integration Processing Unit 760 According to Fourth Embodiment>>

As described in the first embodiment, the range-velocity map (M_{rd1}) created in the LPRF system and the range-velocity map (M_{rd2}) created in the HPRF system are sent to the integration processing unit 760 according to the fourth embodiment. The range-velocity map (M_{rd1}) and the range-velocity map (M_{rd2}) are decomposed into each of components by a filter bank held by the integration processing unit 760.

The integration processing unit 760 according to the fourth embodiment performs coherent integration on each component after matching phases of the two range-velocity maps. In general, it is not easy to know the phase difference between two range-velocity maps. In view of this, the integration processing unit 760 according to the fourth embodiment specifically performs processing given by the following expression.

$${M}_{rd} ( {n}_{r} , {n}_{d} , {n}_{az} , {n}_{el} , {n}_{f} ) := {M}_{rd 1} ( {n}_{r} , {n}_{d} , {n}_{az} , {n}_{el} ) + {M}_{rd 2} ( {n}_{r} , {n}_{d} , {n}_{az} , {n}_{el} ) exp ( - j 2 π \frac{{n}_{f} - 1}{{N}_{f}} ) \qquad ( 20 )$$

As represented by Expression (20), the radar apparatus according to the fourth embodiment prepares a filter bank including N_{f} bandpass filters in advance, performs phase correction on one of the range-velocity map (M_{rd1}) and the range-velocity map (M_{rd2}) at an integral multiple of 2π/N_{f}, and then performs coherent integration. In the present specification, M_{rd} on the left side of Expression (20) is referred to as coherent integration signal (M_{rd}).

The integration processing unit 760 according to the fourth embodiment may calculate p_{rd} from the coherent integration signal (M_{rd}) on the basis of the relationship indicating that the square of a signal amplitude represents power. The calculation of p_{rd} performed by the integration processing unit 760 is given by the following expression as a concept.

$${p}_{rd} = {\vert {M}_{rd} \vert}^{2} \qquad ( 21 )$$

Expression (21) according to the fourth embodiment corresponds to Expression (3) according to the first embodiment.

### <<Target Detection Processing Unit 3000 (3000-#1, 3000-#2, . . . , 3000-#N_{f}) According to Fourth Embodiment>>

The Target Detection Processing Unit 3000 (3000-#1, 3000-#2, . . . , 3000-#N_{f}) according to the fourth embodiment detects the target (Tgt) by regarding a signal coherently integrated with the smallest loss in the filter bank as a target signal related to the target (Tgt).

As described above, the radar apparatus according to the fourth embodiment has the above configuration, and thus, can coherently integrate the range-velocity map (M_{rd1}) created in the LPRF system and the range-velocity map (M_{rd2}) created in the HPRF system. With this effect, the radar apparatus according to the fourth embodiment has an effect of being capable of improving an SN ratio in addition to the effect described in the first embodiment.

### Fifth Embodiment

A radar apparatus according to a fifth embodiment is a modification of the radar apparatus according to the present disclosure. Unless otherwise specified, the same reference signs as those used in the previously described embodiments are used in the fifth embodiment. In addition, in the fifth embodiment, the description overlapping with those of the previously described embodiments is appropriately omitted.

The radar apparatus according to the fifth embodiment assumes that an LPRF transmitter 110 and an HPRF transmitter 210 perform transmission over a plurality of coherent processing intervals (CPIs).

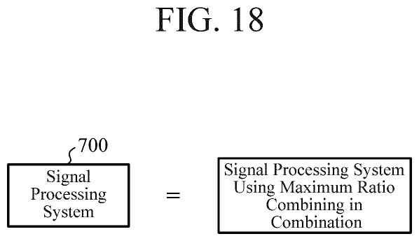

FIG. 18 is an explanatory diagram illustrating a mode of a partial functional block in the radar apparatus according to the fifth embodiment. As illustrated in FIG. 18, the radar apparatus according to the present disclosure may perform signal processing using maximum ratio combining.

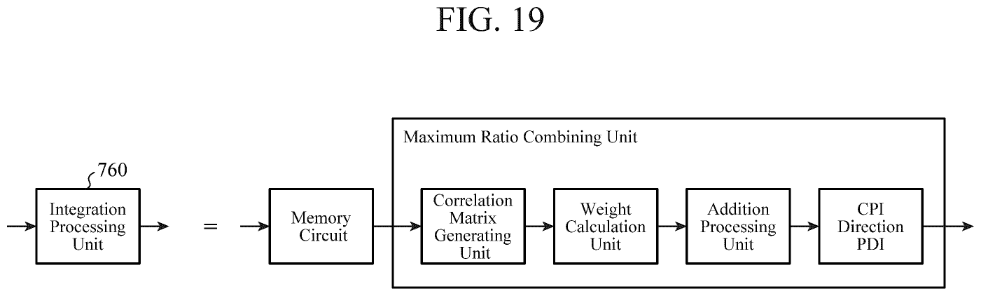

FIG. 19 is a block diagram illustrating the detailed functional configuration of an integration processing unit 760 in the radar apparatus according to the fifth embodiment. As illustrated in FIG. 19, the signal processing using maximum ratio combining in combination may be implemented by the integration processing unit 760 including a memory circuit and a maximum ratio combining unit. Furthermore, the maximum ratio combining unit may include a correlation matrix generating unit, a weight calculation unit, an addition processing unit, and a CPI direction PDI.

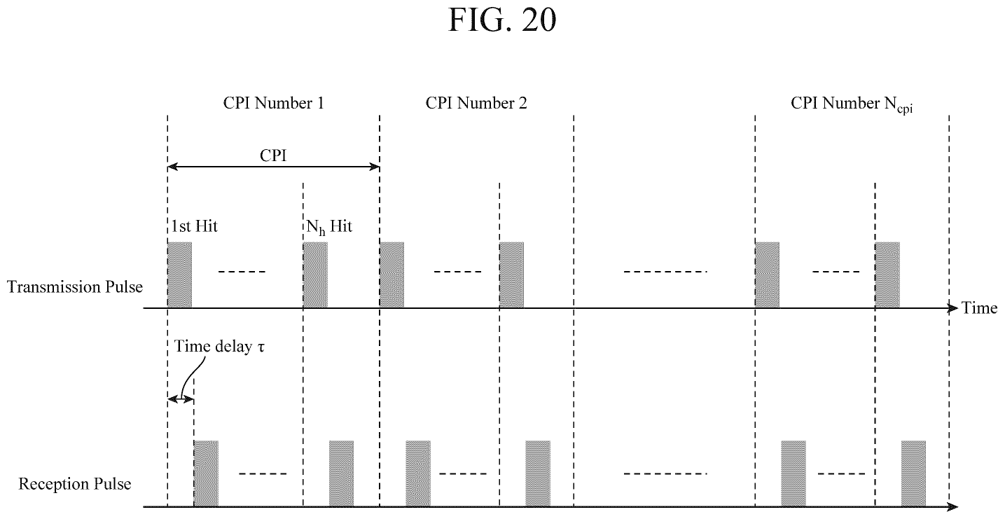

FIG. 20 is an explanatory diagram illustrating, in time series, a state in which the radar apparatus according to the fifth embodiment performs transmission and reception over a plurality of CPIs. N_{cpi} in “CPI number N_{cpi}” described in FIG. 20 is a total number of CPIs.

### <<Integration Processing Unit 760 According to Fifth Embodiment>>

The memory circuit included in the integration processing unit 760 according to the fifth embodiment is a component that stores a signal as a signal transmitted on a CPI basis.

The correlation matrix generating unit included in the integration processing unit 760 according to the fifth embodiment is a component that generates a correlation matrix of a transmitted signal.

The weight calculation unit included in the integration processing unit 760 according to the fifth embodiment is a component that outputs an eigenvector corresponding to the maximum eigenvalue of the correlation matrix as a weight.

The addition processing unit included in the integration processing unit 760 according to the fifth embodiment is a component that performs addition processing using a weight.

The CPI direction PDI included in the integration processing unit 760 according to the fifth embodiment is a component that performs incoherent integration in the CPI direction.

As described above, the radar apparatus according to the fifth embodiment assumes that the LPRF transmitter 110 and the HPRF transmitter 210 perform transmission over a plurality of CPIs (this assumption is referred to as “premise specific to the fifth embodiment” below). That is, in an interpolation processing unit 750 of a signal processing system 700 according to the fifth embodiment, a range-velocity map is transmitted on a CPI basis from both the range-velocity map generating unit 740-1 of the LPRF system and from the range-velocity map generating unit 740-2 of the HPRF system. As described above, the range-velocity map uses nᵣ, n_{d}, n_{az}, and nₑₗ as arguments, for example, as represented in Expression (3). In the signal processing system 700 according to the fifth embodiment, the range-velocity map has a premise specific to the fifth embodiment, and thus, it is necessary to further add a number (hereinafter referred to as “CPI number (n_{cpi})” or simply “n_{cpi}”) for identifying the number of CPI as an argument in addition to the four arguments.

Therefore, in the present specification, only n_{cpi} is described as the argument, and nᵣ, n_{d}, n_{az}, and nₑₗ are omitted from the range-velocity map in the fifth embodiment in consideration of visibility.

As described above, the correlation matrix generating unit included in the integration processing unit 760 according to the fifth embodiment generates a correlation matrix of a transmitted signal. Specifically, the correlation matrix generating unit included in the integration processing unit 760 generates a correlation matrix (R) given by the following expression.

$$R := {A}^{H} A wherein \qquad ( 22 )$$

$$A := [ \begin{matrix}{M}_{rd 1} ( 1 ) , & {M}_{rd 2} ( 1 ) \\ {M}_{rd 1} ( 2 ) , & {M}_{rd 2} ( 2 ) \\ ⋮ & ⋮ \\ {M}_{rd 1} ( {n}_{cpi} ) , & {M}_{rd 2} ( {n}_{cpi} ) \\ ⋮ & ⋮ \\ {M}_{rd 1} ( {N}_{cpi} ) , & {M}_{rd 2} ( {N}_{cpi} )\end{matrix} ]$$

Here, the superscript H attached to the matrix A indicated in Expression (22) represents Hermitian transposition. Similar to N_{cpi} in FIG. 20, N_{cpi} appearing in Expression (22) is the total number of CPIs. That is, n_{cpi} is a natural number from 1 to N_{cpi}. The row size of the matrix A indicated in Expression (22) is N_{cpi}.

As described above, the weight calculation unit included in the integration processing unit 760 according to the fifth embodiment calculates an eigenvector (wₘₐₓ) corresponding to the maximum eigenvalue (λₘₐₓ) of the correlation matrix (R) in order to calculate the weight coefficient. The maximum eigenvalue (λₘₐₓ) and the eigenvector (wₘₐₓ) of the correlation matrix (R) have the following relationship.

$${Rw}_{max} = {λ}_{max} {w}_{max} \qquad ( 23 )$$

$${w}_{max} = [ \begin{matrix}{w}_{max , 1} \\ {w}_{max , 2}\end{matrix} ]$$

The lower part of Expression (23) indicates the components of the eigenvector (wₘₐₓ), and the components (w_{max,1} and w_{max,2}) of the eigenvector (wₘₐₓ) are used as a weight coefficient.

As described above, the addition processing unit included in the integration processing unit 760 according to the fifth embodiment performs weighted addition. Specifically, the weighted addition performed by the addition processing unit is given by the following expression.

$${M}_{rd} ( {n}_{cpi} ) := {w}_{max , 1} {M}_{rd 1} ( {n}_{cpi} ) + {w}_{max , 2} {M}_{rd 2} ( {n}_{cpi} ) \qquad ( 24 )$$

Expression (24) indicates weighted addition using the eigenvector (wₘₐₓ) corresponding to the maximum eigenvalue (λₘₐₓ) of the correlation matrix (R), and achieves maximum ratio combining. Expression (24) according to the fifth embodiment corresponds to Expression (20) according to the fourth embodiment.

As described above, the CPI direction PDI included in the integration processing unit 760 according to the fifth embodiment performs incoherent integration in the CPI direction on the processing result (M_{rd}) of the addition processing unit. The incoherent integration in the CPI direction performed by the CPI direction PDI is specifically given by the following expression.

$${p}_{rd} = {\sum }_{{n}_{cpi} = 1}^{{N}_{cpi}} {\vert {M}_{rd} ( {n}_{cpi} ) \vert}^{2} \qquad ( 25 )$$

Expression (25) according to the fifth embodiment corresponds to Expression (3) according to the first embodiment and Expression (21) according to the fourth embodiment.

As described above, the radar apparatus according to the fifth embodiment has the above configuration, and thus, can perform maximum ratio combining on the range-velocity map (M_{rd1}) created in the LPRF system and the range-velocity map (M_{rd2}) created in the HPRF system. With this effect, the radar apparatus according to the fifth embodiment has an effect of being capable of improving an SN ratio in addition to the effect described in the first embodiment.

### Sixth Embodiment

A radar apparatus according to a sixth embodiment is a modification of the radar apparatus according to the present disclosure. Unless otherwise specified, the same reference signs as those used in the previously described embodiments are used in the sixth embodiment. In addition, in the sixth embodiment, the description overlapping with those of the previously described embodiments is appropriately omitted.

The first to fifth embodiments are based on the premise that ambiguity (more precisely, a virtual image including ambiguity) appears at a position that can be theoretically obtained. The radar apparatus according to the sixth embodiment assumes a case where the position of a plot obtained by actual measurement slightly deviates from the position theoretically obtained in the range-velocity map.

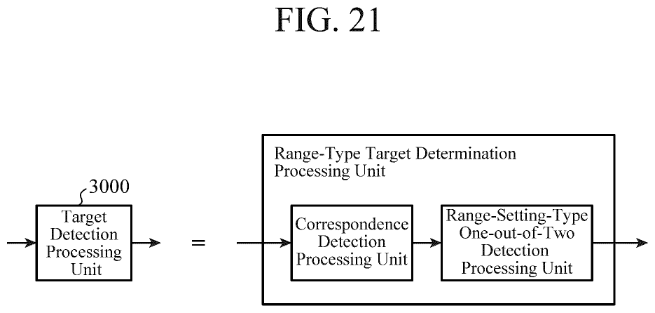

FIG. 21 is an explanatory diagram illustrating a mode of a partial functional block in the radar apparatus according to the sixth embodiment. As illustrated in FIG. 21, in the radar apparatus according to the present disclosure, a target detection processing unit 3000 may be implemented by a range-type target determination processing unit including a correspondence detection processing unit and a range-setting-type one-out-of-two detection processing unit.

### <<Target Detection Processing Unit 3000 According to Sixth Embodiment>>

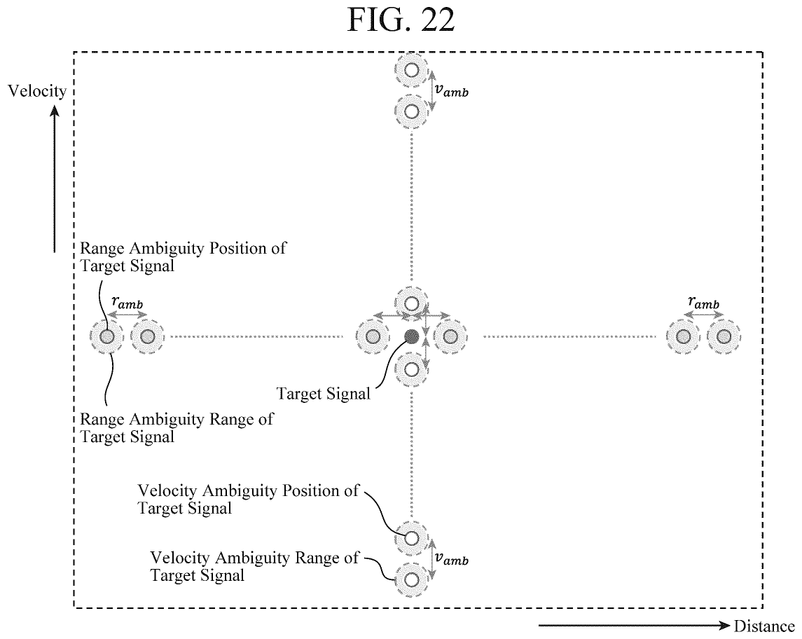

The range-setting-type one-out-of-two detection processing unit included in the target detection processing unit 3000 according to the sixth embodiment is a component that sets a signal in the vicinity of a position where ambiguity is generated as a signal within the range of the ambiguity of the target signal related to the target (Tgt) and then performs detection of one out of two. What is meant by the “vicinity of the position where ambiguity is generated” is apparent from the following description of FIG. 22.

FIG. 22 is a range-velocity map for describing a state in which the radar apparatus according to the sixth embodiment sets an ambiguity range. In the range-velocity map illustrated in FIG. 22, a circle described as a “target signal” at the center indicates a real image of a target signal related to a target (Tgt) not including ambiguity. In the range-velocity map illustrated in FIG. 22, other circles plotted at positions not the center indicate virtual images of the target signal related to the target (Tgt) including ambiguity. A broken line circle outside each circle indicating a virtual image of the target signal related to the target (Tgt) indicates an area for which range setting is performed by the target detection processing unit 3000 according to the sixth embodiment.

Note that FIG. 22 is an example of a range-velocity map in a case where there is one target (Tgt).

The radar apparatus according to the sixth embodiment determines that a plot appearing in an area subjected to range setting by the target detection processing unit 3000 is a virtual image related to the target (Tgt) of interest.

As described above, the radar apparatus according to the sixth embodiment has the above-described configuration, and thus, even when a virtual image related to the target (Tgt) of interest appears at a position slightly shifted from a position theoretically obtained, the radar apparatus can process the virtual image as information related to the target (Tgt) of interest.

Note that the radar apparatus according to the present disclosure is not limited to the mode described in each embodiment, and it is possible to combine the embodiments, to modify any component in the embodiments, or to omit any component in the embodiments.

### INDUSTRIAL APPLICABILITY

The radar apparatus according to the present disclosure can be applied to a technical field for measuring the position and velocity of a target to be observed, and thus is industrially applicable.

### REFERENCE SIGNS LIST

100: LPRF radar transmission system, 110: LPRF transmitter, 120: LPRF transmission antenna, 200: HPRF radar transmission system, 210: HPRF transmitter, 220: HPRF transmission antenna, 600: reception system, 610: element antenna, 620: beam-forming unit, 630: band pass filter, 640: receiver, 650: mixing unit, 700: signal processing system (signal processor), 710: AD converter, 720: pulse hit direction processing unit (pulse hit direction processor), 730: pulse compression unit (pulse compressor), 730-F-1: reception pulse FFT unit (reception pulse FFT), 730-F-2: pulse direction CZT unit (pulse direction CZT), 730-F-3: reference pulse generating unit (reference pulse generator), 730-F-4: reference pulse FFT unit (reference pulse FFT), 730-F-5: multiplication unit (multiplier), 730-F-6: IFFT processing unit (IFFT processor), 740: range-velocity map generating unit (range-velocity map generator), 750: interpolation processing unit (interpolation processor), 760: integration processing unit (integration processor), 770: comparison processing unit (comparison processor), 1000: LPRF radar device (LPRF-Radar), 2000: HPRF radar device (HPRF-Radar), 3000: target detection processing unit (target detection processor).

What is claimed is:

1. A radar apparatus comprising:
an LPRF-Radar to emit an LPRF radio wave toward atmosphere and receive a reflection wave reflected by a target; and
an HPRF-Radar to emit an HPRF radio wave toward atmosphere and receive the reflection wave reflected by the target, wherein
the LPRF-Radar and the HPRF-Radar each include a signal processor including an LPRF system and an HPRF system,
the radar apparatus further comprising a target detection processor to detect a position and a velocity of the target on a basis of information transmitted from the signal processor included in the LPRF-Radar and information transmitted from the signal processor included in the HPRF-Radar,
and wherein,
the signal processor included in each of the LPRF-Radar and the HPRF-Radar includes,
a range-velocity map generator to generate a range-velocity map;
an interpolation processor to interpolate and correct a range bin and a Doppler bin in the range-velocity map in consideration of information obtained by the LPRF system and information obtained by the HPRF system;
an integration processor to perform integration processing; and
a comparison processor to compare a component of a signal processed by the integration processor with a preset threshold value.

2. The radar apparatus according to claim 1, wherein
the LPRF-Radar further includes:
an LPRF radar transmission system including an LPRF transmitter and an LPRF transmission antenna; and
a reception system including a band pass filter that includes bandpass filters for a band of an LPRF pulse and a band of an HPRF pulse, respectively, and
the signal processor processes a signal transmitted from the reception system.

3. The radar apparatus according to claim 1, wherein
the HPRF-Radar further includes:
an HPRF radar transmission system including an HPRF transmitter and an HPRF transmission antenna; and
a reception system including a band pass filter that includes bandpass filters for a band of an LPRF pulse and a band of an HPRF pulse, respectively, and
the signal processor processes a signal transmitted from the reception system.

4. A radar apparatus comprising:
an LPRF-Radar to emit an LPRF radio wave toward atmosphere and receive a reflection wave reflected by a target; and
an HPRF-Radar to emit an HPRF radio wave toward atmosphere and receive the reflection wave reflected by the target, wherein
the LPRF-Radar and the HPRF-Radar each include a signal processor including an LPRF system and an HPRF system,
the radar apparatus further comprising a target detection processor to detect a position and a velocity of the target on a basis of information transmitted from the signal processor included in the LPRF-Radar and information transmitted from the signal processor included in the HPRF-Radar,
and wherein,
the target detection processor
compares information about a structure transmitted from the signal processor in the LPRF-Radar with information about a structure transmitted from the signal processor in the HPRF-Radar, checks in which record a certain identical target among the targets appears in each of the structures, and
performs processing in such a way as to be able to also output a result detected by only one of the LPRF-Radar and the HPRF-Radar as a detection result.

5. The radar apparatus according to claim 1, wherein the integration processing performed by the integration processor is post detection integration.

6. The radar apparatus according to claim 1, wherein
the signal processor includes:
a pulse hit direction processor to correct phase rotation of a signal due to a Doppler frequency using a set of velocities of the target assumed in advance and then perform coherent integration in a pulse hit direction; and
a pulse compressor to correct a frequency shift in a power spectrum of a target signal due to Doppler and perform pulse compression.

7. The radar apparatus according to claim 1, wherein
the signal processor includes:
a reception pulse FFT to perform FFT in a distance direction;
a pulse direction CZT to perform chirp z-transform in a pulse hit direction;
a reference pulse generator to generate a reference pulse used for pulse compression processing;
a reference pulse FFT to perform FFT on the reference pulse;
a multiplier to multiply a signal from the pulse direction CZT by a signal from the reference pulse FFT; and
an IFFT processor to perform inverse Fourier transform.

8. The radar apparatus according to claim 1, wherein
the integration processor includes a filter bank that includes a plurality of bandpass filters, and
the target detection processor performs target detection processing on a signal component that has passed through each of the bandpass filters.

9. The radar apparatus according to claim 1, wherein
the integration processor includes:
a correlation matrix generator to generate a correlation matrix of signals transmitted on a CPI basis;
a weight calculator to output an eigenvector corresponding to a maximum eigenvalue of the correlation matrix as a weight;
an addition processor to perform addition processing using the weight; and
a CPI direction PDI to perform incoherent integration in a CPI direction.

10. The radar apparatus according to claim 4, wherein
the target detection processor sets a signal near a position where ambiguity is occurred to be within a range of the ambiguity of the target signal related to the target,
wherein, the occurrence of ambiguity refers to the occurrence of velocity ambiguity, distance ambiguity, or both.
